(19) United States
(12) Patent Application Publication
(10) Pub. No.: US 2025/0138487 A1
(43) Pub. Date: May 1, 2025

(54) ASTRONOMICAL DISPLAY

(71) Applicant: Preciflex SA, Neuchâtel (CH)

(72) Inventors: Johann ROHNER, Pomy (CH); Grégory DOURDE, Neuchâtel (CH); Toralf BORK, Enges (CH); Alain JACCARD, Sainte- Croix (CH); Sandro REGINELLI, La Neuville (CH)

(21) Appl. No.: 17/874,333

(22) PCT Filed: Jan. 29, 2021
(86) PCT No.: PCT/IB2021/050723

§ 371 Date: Jul. 27, 2022

Related U.S. Application Data
(60) Provisional application No. 62/967,299, filed on Jan. 29, 2020.
(60) Provisional application No. 63/115,628, filed on Nov. 19, 2020.

(51) Int. Cl. G04B 45/00; G04B 49/00

(52) U.S. Cl. CPC G04B 45/0007; G04B 49/00

(57) ABSTRACT

A non-electric display system configured to be integrated in an accessory to be worn by a wearer/user as a piece of apparel, an item of jewelry, a wristwatch, a pocket watch or any other fashion item and includes at least one electrical light source for illuminating the display. The light source is hidden when not activated.

### CROSS REFERENCE TO RELATED APPLICATIONS

This application claims the benefit of U.S. Provisional Application No. 62/967,299 filed Jan. 29, 2020 and U.S. Provisional Application No. 63/115,628 filed Nov. 19, 2020, the content of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

The invention relates to a new way of displaying analogic information as can be observed in nature on three dimensional bodies, for example a substantially spherical body, moon phase, day/night, or constellations, in wearable devices such as pocket watches, wristwatches, necklaces etc. The existing art displays such information with flat elements that are simple to actuate mechanically, and sometimes three dimensional objects, but the resulting display does not correspond to the reality.

Traditionally dynamic information in portable/wearable devices such as watches is displayed either by means of mechanical parts such as watch hands or panels changing position or by means of pixelated or segmented displays, where the light emission or absorption characteristics of pixels located in groups of pixels forming an image are dynamically modified, thereby providing a visual animation or an indication. The user/wearer expects the dynamic information to be shown in such ways, because the mechanical parts and/or pixelated displays are visible and identifiable in ambient light conditions. In many cases, the mechanical parts include phosphorescent or similar coatings so that they remain visible and identifiable even when there is no ambient light. The invention relates to new ways of displaying dynamic information, in a manner that cannot be easily anticipated by the user/wearer, providing a surprising effect.

What is needed is a novel display system that resembles the observable reality to represent astronomical positions in an intellectually interesting way.

Still further, what is needed is a novel display system that is not easily identifiable as such when not in use, so as to provide information or a visual animation in an unexpected way.

### SUMMARY OF THE INVENTION

A non-electric (i.e., mechanical, non-electronic, non-liquid-crystal, and without using illuminated pixels, but using a light source, be it electronic or not) display system and method/apparatus is provided which is configured to be integrated in an accessory to be worn by a wearer/user as a piece of apparel, an item of jewelry, a wristwatch, a pocket watch or any other fashion item and includes at least one electrical light source for illuminating the display. The light source is hidden when not activated.

The system further provides a means to display the observable reality of astronomical positions in an intellectually interesting way. The invention displays dynamic information or visual animations in a manner that cannot be easily anticipated by the user/wearer, providing a surprising effect.

### BRIEF DESCRIPTION OF THE DRAWINGS

The attached drawings represent, by way of example, different embodiments of the subject of the invention.

FIGS. 1A-1B are examples of integration of the system of the invention in a wristwatch.

FIGS. 2A-2B are examples of angles of viewing the system of the invention in a wristwatch.

FIGS. 3A-3B show the most commonly used system in the prior art.

FIG. 4 shows the naturally observable phenomenon that the display of the system of the invention reproduces.

FIG. 5 shows the display produced by systems of the prior art.

FIG. 6A is a cross-sectional side view of a first embodiment of the invention.

FIG. 6B is a general view of the first embodiment of the invention.

FIG. 6C is a combined view of the first embodiment of the invention and the resulting display in three different positions.

FIG. 7A is a cross-sectional side view of a second embodiment of the invention.

FIG. 7B is a partial top view of the second embodiment of the invention.

FIG. 8A is a cross-sectional side view of a third embodiment of the invention.

FIG. 8B is a partial top view of the third embodiment of the invention.

FIG. 9A is a cross-sectional side view of a fourth embodiment of the invention.

FIG. 9B is a partial top view of the fourth embodiment of the invention.

FIG. 9C is a view of display results of the fourth embodiment of the invention.

FIG. 10A is a partial sectional view of a fifth embodiment of the invention.

FIG. 10B is a cross-sectional top view of the fifth embodiment of the invention.

FIG. 10C is a view of the display result of the fifth embodiment of the invention.

FIG. 11A is a partial sectional view of a sixth embodiment of the invention.

FIG. 11B is 4 cross-sectional side views of the sixth embodiment of the invention in 4 different positions.

FIG. 12A is a general view of a seventh embodiment of the invention.

FIG. 12B shows 4 cross-sectional side views of the seventh embodiment of the invention in 4 different positions.

FIG. 12C shows 4 cross-sectional side views of the seventh embodiment of the invention in 4 different positions and the corresponding displays.

FIG. 12D is a cross-sectional side view of the seventh embodiment of the invention between 2 moon cycles.

FIG. 12E is a top view of the seventh embodiment of the invention between 2 moon cycles.

FIG. 13A is a general view of a wristwatch using an eighth and/or a ninth embodiment of a display according the invention when the display is not activated.

FIG. 13B is the general view of the wristwatch of FIG. 13A when the display is activated.

FIG. 13C is a cross-sectional view of the eighth embodiment of the system of the invention.

FIG. 13D is a cross-sectional view of the ninth embodiment of the system of the invention.

FIG. 13E is an exploded view of the mechanism of the eight and ninth embodiments of the system of the invention when the display is not activated.

FIG. 13F is the exploded view of FIG. 13E when the display is activated.

FIG. 14A is a plan view of a wristwatch using a tenth or an eleventh embodiment of a display according the invention when the display is not activated.

FIG. 14B is the plan view of the wristwatch of FIG. 14A when the display is activated and displays an information/animation.

FIG. 14C is the plan view of FIG. 14A when the display is activated and displays another information/animation.

FIG. 14D is a cross-sectional view of the tenth embodiment of the system of the invention.

FIG. 14E is a cross-sectional view of the eleventh embodiment of the system of the invention.

FIG. 15A is a plan view of a wristwatch using a twelfth embodiment of a display according the invention when the display is not activated.

FIGS. 15B-15E are plan views of the wristwatch of FIG. 15A when the display is activated and shows different information or animations.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended to distinguish between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

The system and method/apparatus according to this invention provides means to display dynamic information or visual animations in a manner that cannot be easily anticipated by the user/wearer, providing a surprising effect, and is configured to be integrated in an accessory to be worn by a wearer/user such as a piece of apparel, an item of jewelry, a wristwatch, a pocket watch or any other fashion item.

The system and method/apparatus according to this invention includes at least one light source that is hidden, i.e., installed in such a way as to be invisible or integrated so as to be non-identifiable (i.e., camouflaged) as such by the user/wearer when not in use. The light source is one or more light emitting diodes (LED) or any other light producing elements, powered by one or more photovoltaic cells converting ambient light into electricity, by one or more batteries, by one or more electrochemical devices producing electricity, or by one or more micro-generators converting mechanical energy into electricity such as the miniature user-powered lighting device described in application PCT/IB2016/000249 filed on 7 Mar. 2016 by the same applicant, the content of which is explicitly incorporated herein by reference and relied upon to define features for which protection may be sought hereby as it is believed that the entirety thereof contributes to solving the technical problem underlying the invention, some features that may be mentioned hereunder being of particular importance. Optionally the energy to power the light source may be produced in advance and stored until use in one or more energy storage devices such as rechargeable batteries, electrochemical devices, mechanical energy storage arrangements such as springs, spiral springs, spring barrels, or fluids compressed in one or more reservoirs. Where the system includes more than one light source, the light sources may have different sizes and colors, as appropriate for the information/animation to be displayed.

In one embodiment, the system according to this invention provides an indication of an astronomical positioning such as day/night, moon phase, season, etc. in a manner that mimics observable reality and is configured to be integrated in an accessory to be worn by a wearer/user as a piece of apparel, an item of jewelry, a wristwatch, or any other fashion item.

Referring now to FIGS. 1A-1B, the display 12 of the system of the invention is placed typically on the face of a wrist watch 10, for example at the 6 o'clock position (FIG. 1A) or at the 3 o'clock position (FIG. 1B), or any other position on a wristwatch face.

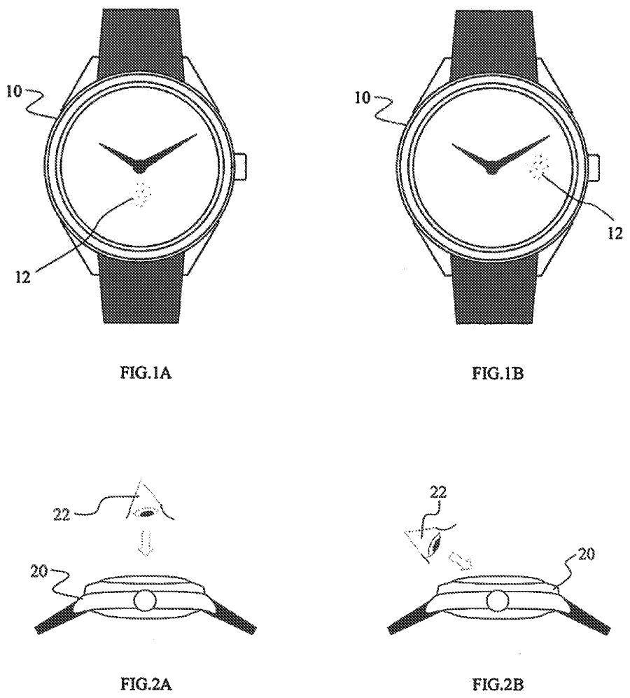

Referring now to FIGS. 2A-2B, the display of the system of the invention can be placed so as to be visible when the user/wearer's eye 22 is facing the face of the wristwatch 20 (FIG. 2A), but it may as well be constructed so that the user/wearer's eye 22 can only see the display when viewing it at a certain angle relative to the face of the wristwatch 20 (FIG. 2B).

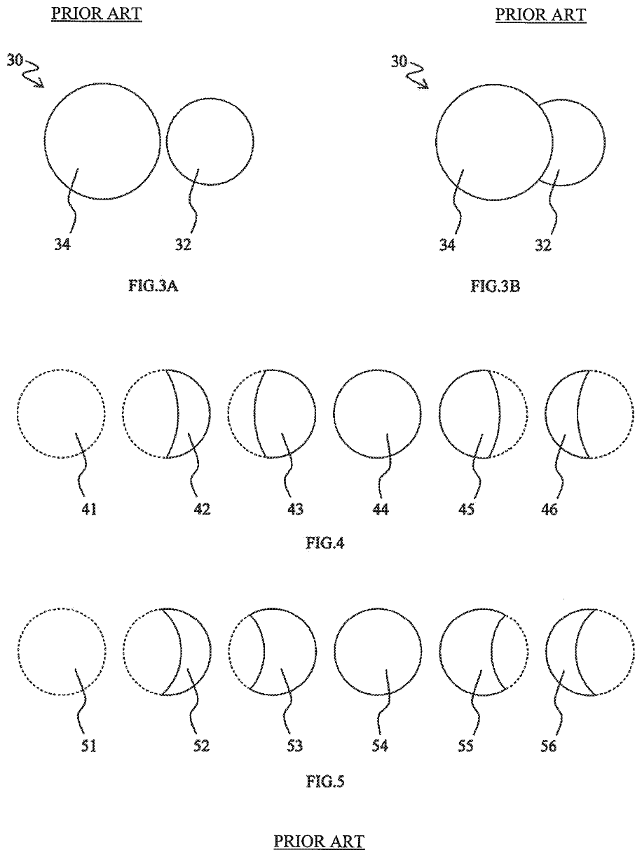

Referring now to FIGS. 3A-3B, the systems of the prior art are made on the basis of a picture of an element 32 (for example the moon), that is progressively hidden by a mask 34. The element 32 which is to be progressively hidden may be fixed, in such case the mask 34 shall move over it, or in other cases the mask 34 may be fixed and the element 32 moves under it.

Referring now to FIG. 4, the observation of a natural phenomenon like the moon phases shows that the shape of the illuminated part of the moon changes over the moon phases:
41: Newmoon
42: Waxing crescent
43: Waxing gibbous
44: Full moon
45: Waning gibbous
46: Waning crescent

For example, in the waxing crescent 42 and in the waning crescent 46, the illuminated part of the moon is concave, and in the waxing gibbous 43 and in the waning gibbous 45, the illuminated part of the moon is convex. Similarly, observing the planet Earth or any other planet from space would show a similar illumination phenomenon.

Referring now to FIG. 5, the display as provided in the current art shows the illuminated part of the moon phases as follows:
51: New moon as in current art
52: Waxing crescent as in current art
53: Waxing gibbous as in current art
54: Full moon as in current art
55: Waning gibbous as in current art
56: Waning crescent as in current art

It is particularly visible in the gibbous phases (52 vs 42, 56 vs 46) that the systems of the current art do not provide a display that represents the reality.

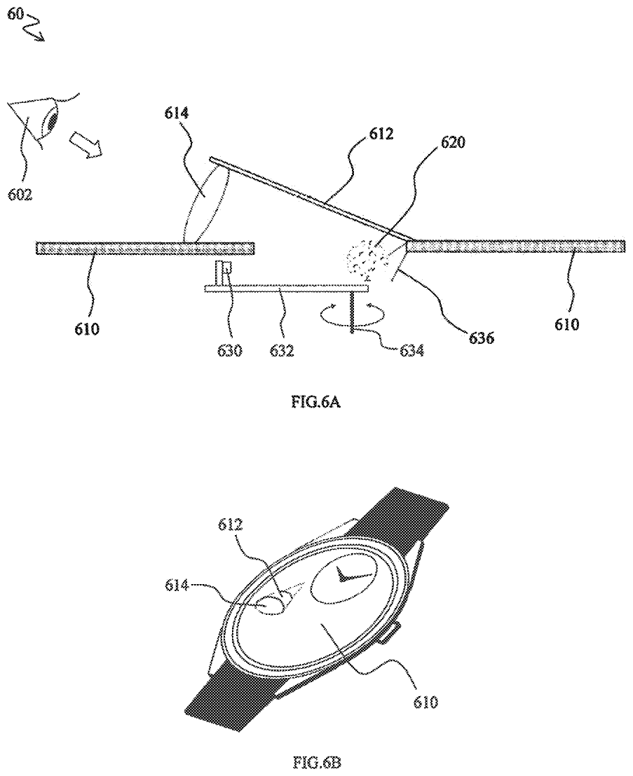

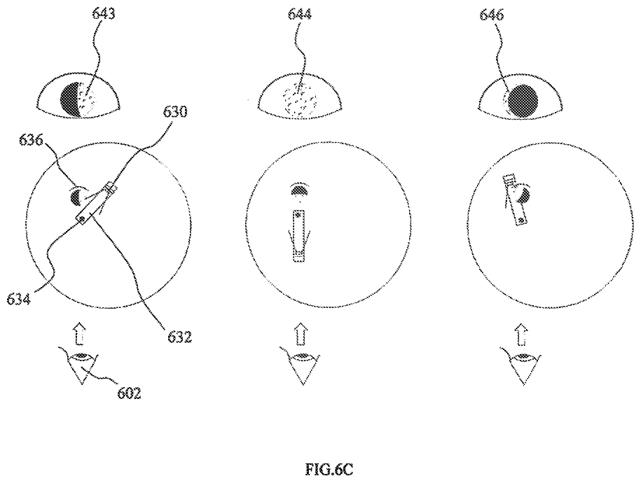

Referring now to FIGS. 6A to 6C, a first embodiment of the system 60 of the invention reproduces the reality by illuminating miniature substantially or partially spherical object 620 (for example, a representation of the moon such as a spherical shape or a shape including a section of a sphere) with a light source 630 (for example a LED), the light source 630 being installed on a rotatable lever 632 whose rotation axis 634 is placed near the spherical object 620 and whose direction is as near as possible to the perpendicular of the observation axis. For example, in order to represent the moon phases, the rotatable lever 632 makes one turn in 29.53 days, corresponding to the cycle of the moon. In such case, a traditional moon phase mechanism may be used, and an approximation of the 29.53 days cycles may be used, for example 29.5, 30, etc. For a representation of another natural phenomenon, for example the planet Earth as visible from the space station, another period of rotation of the rotatable lever 632 may be selected. In order to ensure a realistic vision of the illumination of the spherical object 620, the system 60 is hidden below a mask 610, that may be the dial of a wristwatch for example. The field of vision of the observer's eye 602 is limited by a three dimensional cover 612, for example representing a telescope, so that the observer can only see a part of the system 60 through a magnifying lens or a combination of several lenses or a window 614 (made of a transparent, translucent and/or tunnel-pin-holed opaque material in which the pin-holed surface allows for viewing of an object only from one viewing direction due to their narrow width and great depth). In this way, the ambient environment light has a very limited impact on the spherical object 620, and the most light illuminating the spherical object 620 comes from the light source 630. Since the observer is de facto looking at a three dimensional object 620, he has the impression of observing the real moon at any time of the day.

When the light source 630 is on the side with respect to the observation direction, the observer sees half shadowed moon 643; when the light source 630 is in front of the moon 620 and emitting in the direction of observation, the observer sees the full face of the moon illuminated 644 and when the light source 630 is behind the moon 620, an optical mask 636 prevents the light from being visible by the observer, the observer then seeing a black moon.

In order to emphase the contrast between shadow and the illuminated part of the moon, the system may be surrounded by light absorbing areas. The moon may also be coated with or formed of light sensitive material.

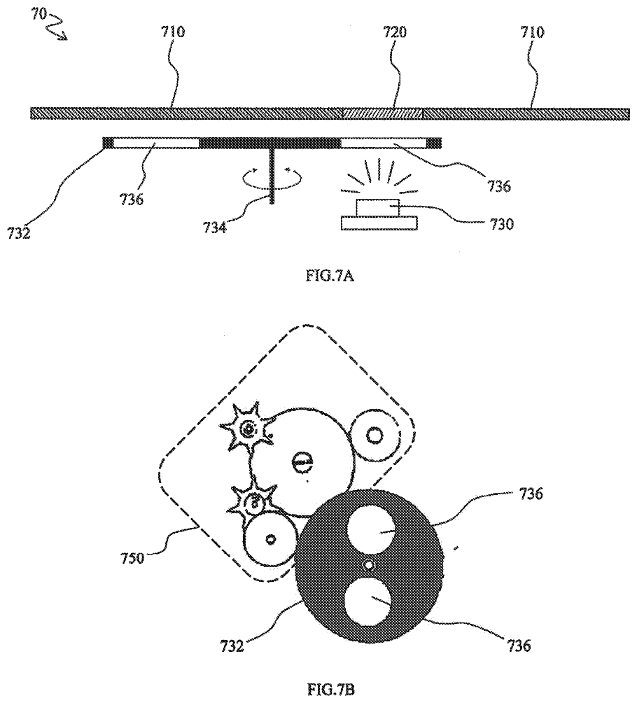

Referring now to FIGS. 7A and 7B, a second embodiment of the system 70 provides a two dimensional (flat) display of the illumination with backlighting. An translucent diffusing window 720 with a representation of the moon is illuminated by a backlight 730. The backlight 730 makes the moon appear full. A rotating mask 732 with two openings 736 is placed between the light source 730 and the diffuser 720 allowing for masking a portion of the translucent window 720 that represent the unlit part of the moon. The mask 732 turns according to a rotation speed of 1 turn in 59.06 days representing two moon cycles. The mechanism of the rotating mask relies on a traditional moon phase mechanism 750 for wrist watches, and may have a slightly different cycle, for example 58, 59, 60 days per cycle.

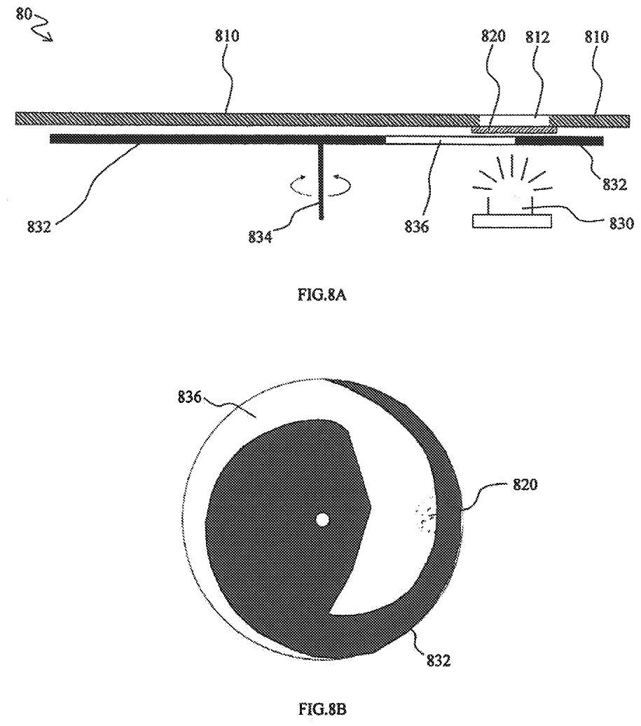

Referring now to FIGS. 8A and 8B, in the third embodiment of the system 80, the system 80 is hidden below a cover 810 with an opening 812, and a diffusing window 820 is placed in or below the opening 812. The diffusing window 820 may have engravings or decorations, for example which represent the surface of the moon. A rotating mask 832 has its axis of rotation 834 at the center of the system 80. A light source 830 (for example one or more LEDs) is located below the rotating mask 832, and illuminates the diffusing window 820 from below (relative to the observer's eye). The rotating mask 832 has an opening 836 with an appropriate shape so that the clipped part of the light has a shape narrowing the real shadow of the light shadow. The rotating mask 832 has a rotation speed of one turn in 29.53 days, corresponding to one cycle of the moon.

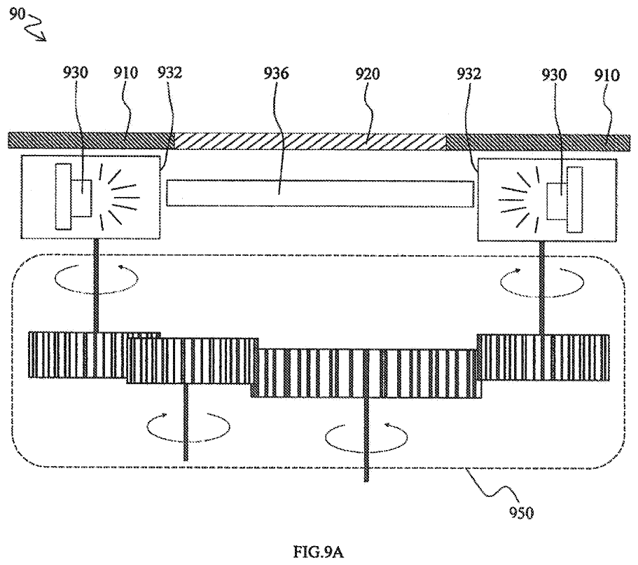

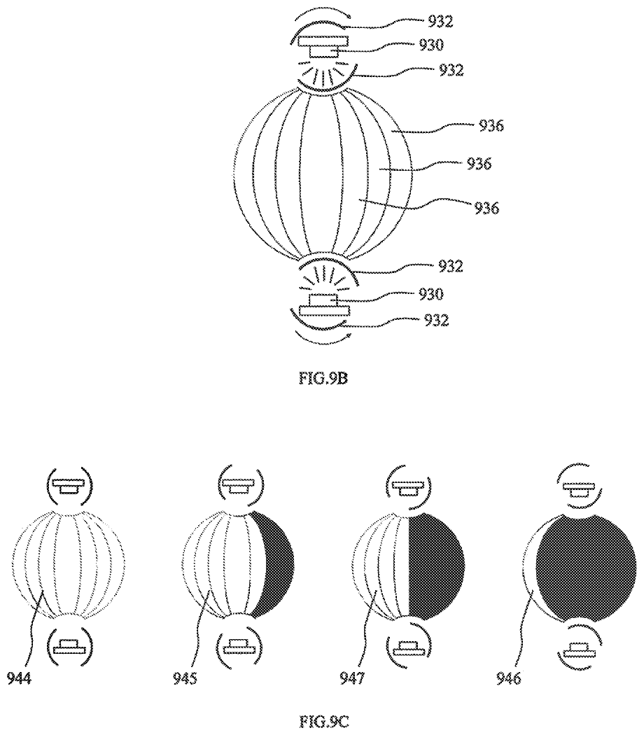

Referring now to FIGS. 9A to 9C, in the fourth embodiment of the system 90, the system is hidden below a cover 910 having a window 920. The moon image is composed of diffusing light guides 936. The lightguides 936 begin at the same point and end at the opposite side of the moon image. They may have a variable width so that they completely fill the entire image. Both sides of the lightguides are arranged so that they present their coupling areas sitting alongside each other and facing two light sources 930. Two rotating masks 932 may be positioned so as to obscure some of the lightguides 936 by rotating around an axis placed under the light sources 930. The two masks 932 rotate in opposite directions so that they clip the light in front of the same lightguides 936 simultaneously. The rotation of the masks 932 is driven for example by a time keeping mechanism 950, for example a watch movement so that they make a turn in 59.06 days representing two moon cycles. The resulting display mimics real observation of the moon, for example: full moon 944, waning gibbous 945, third quarter 947, waning crescent 946.

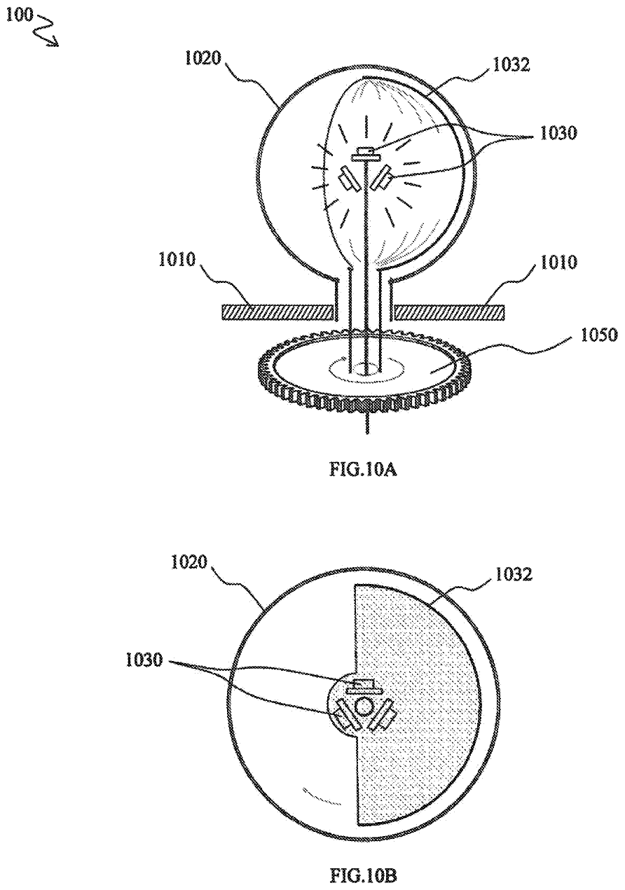

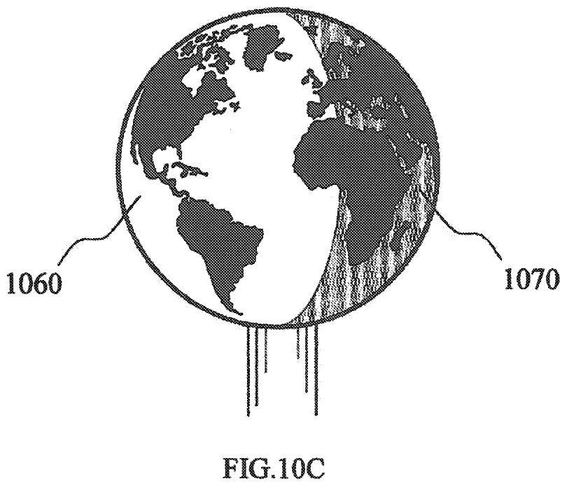

Referring now to FIGS. 10A to 10C, a fifth embodiment of the system 100 provides a solution for the indication of the day-night position (day 1060/night 1070) around the globe. It is composed of a three-dimensional representation of the terrestrial globe 1020 made of semi-transparent or translucent material. The globe 1020 is illuminated from inside by a light source 1030 or several light sources emitting in all directions so that the light distribution is substantially homogeneous. The semi-transparent or translucent representation of the terrestrial globe may also be composed of several segments or even of a multitude of pinholes in order to create the semi-transparency. The segments or pinholes may be advantageously distributed with varying densities in different areas to create varying degrees of semi-transparency in these areas, generating different luminosity for these areas when illuminated, for example to emphase the difference between the continents and the seas. In this configuration, the light source 1030 is fixed. A hemispherical mask 1032 placed inside the globe 1020 and oriented concentrically to the globe blocks the light, darkening half of the globe representing the portion of the earth that is by night 1070. The hemispherical mask 1032 is rotating around its axis collinear to the fixation of the light source 1030. The mask 1032 is driven by a gear 1050 coupled to a time keeping mechanism. The rotation of the mask 1032 makes one turn in 24 hours. The system 100 can be integrated in a fixed clock, in a pocket watch or in a wrist watch. Referring now to FIGS. 11A to 11B, in a sixth embodiment of the system 110, the light source 1130 is not placed at the center of the globe 1120 but is offset and rotates around the central axis. The clipping mask 1132 is placed close to the light source 1130 at a distance so that its shadow darkens half of the globe of the Earth. The rotating mask 1132 and the light source 1130 are rotating at the same speed and make one turn in 24 hours. The clipping mask 1132 can however move up and down along the rotation axis, thanks to a vertical guide 1134. The up and down displacement of the mask 1132 along the axis moves the shadow so that the illuminated hemisphere 1160 makes an angle of up to plus or minus 23° 26′ 12″ with respect to its initial position. An approximation of the 23° 26′ 12″ angle may be used, for example 23° 12′, 23°, etc. The vertical movement of the mask 1132 is controlled by a rotating cam 1136 that makes a turn in one year. The uppermost position of the mask 1132 corresponds to the illumination of the earth globe at the summer solstice 1184 while the lowermost position corresponds to the winter solstice 1188. At the middle position 1182, 1188, the illumination corresponds to the equinoxes. The rotation of the cam 1136 can be controlled by a annual calendar mechanism of a watch or by a perpetual calendar mechanism.

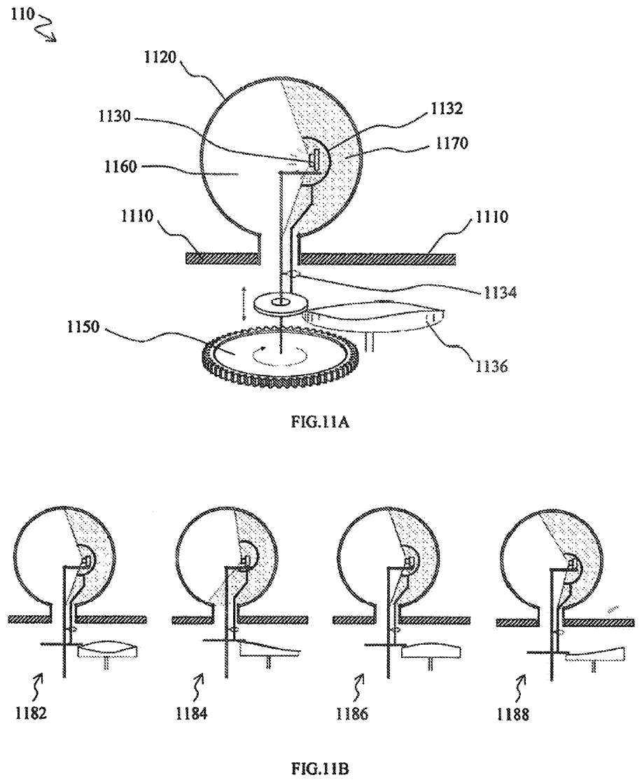

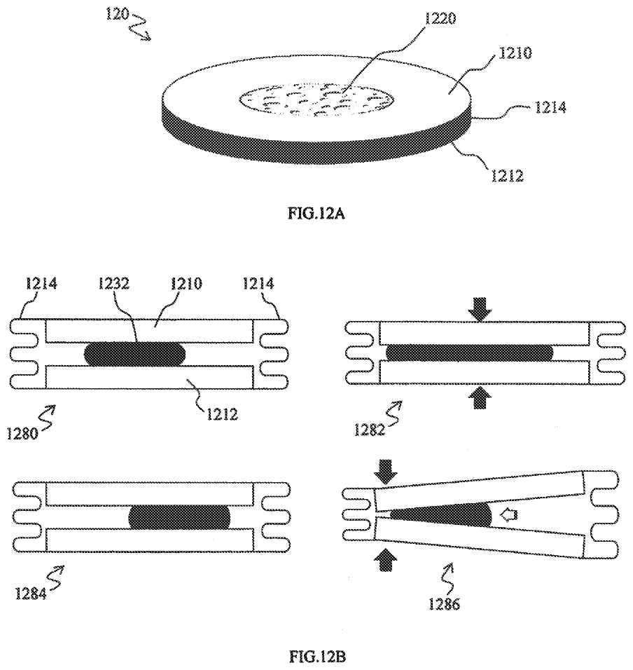

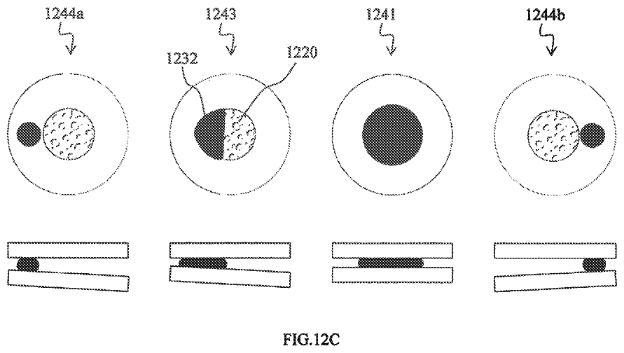

Referring now to FIGS. 12A to 12E, in the seventh embodiment the system 120 shows the indication of the moon phase on a timepiece with a liquid display.

The system is composed of a transparent top plate 1210 and a bottom plate 1212, the bottom plate 1212 containing a representation of the image, typically a moon face 1220, directly on it or under it and visible given the transparency of the plate. The two plates 1210, 1212 are linked together by a flexible system 1214, typically a bellows. A drop of liquid 1232 is trapped between the two plates 1210, 1212 and its shape and position is maintained by capillary forces. The liquid 1232 may be opaque so that, when covering the background image 1220, it hides or partially hides it. The liquid drop 1232 may be colored and/or partially transparent in order to change the shade of the background image 1220 As shown in position 1282 compared to the original position 1280, when the two plates 1210, 1212 get closer while staying parallel, the drop 1232 will spread and cover a larger area of the background image 1220.

As shown in position 1286 compared to the original position 1280, when the two plates 1210, 1212 are tilted with respect to each other, the drop 1232 will move toward the narrowest distance. By combining these two effect, one can drive the drop 2332 and change its size according to a desired pattern. In particular, a black drop of liquid 1232 can cover a moon face 1220 according to the actual moon phase as illustrated in the sequence of FIG. 12C, position 1244a representing a full moon at the beginning of the cycle, position 1243 representing a gibbous waning, position 1241 representing a new moon, position 1244b representing the full moon at the end of the cycle.

Referring now to FIGS. 12D and 12E, after a moon cycle, as shown in position 1244b the droplet 1232 is located on the other side of the moon image 1220 and needs to come back to the initial position 1244a. The movement of the droplet 1232 from position 1244b to position 1244a is obtained by tilting the bottom plate 1212 so as to move the droplet around the moon image 1220. The portion of the path of the drop 1232 that returns to the initial position may be hidden by a mask or dial in the integration of the system, for example, in a watch.

The control of the tilt of the bottom plate 1212 can be accomplished by three cams setting the position of three reference points of the plate.

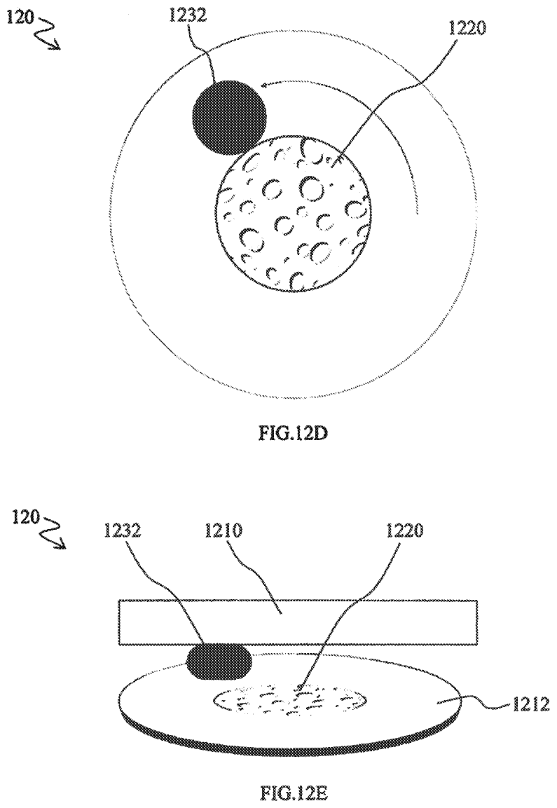

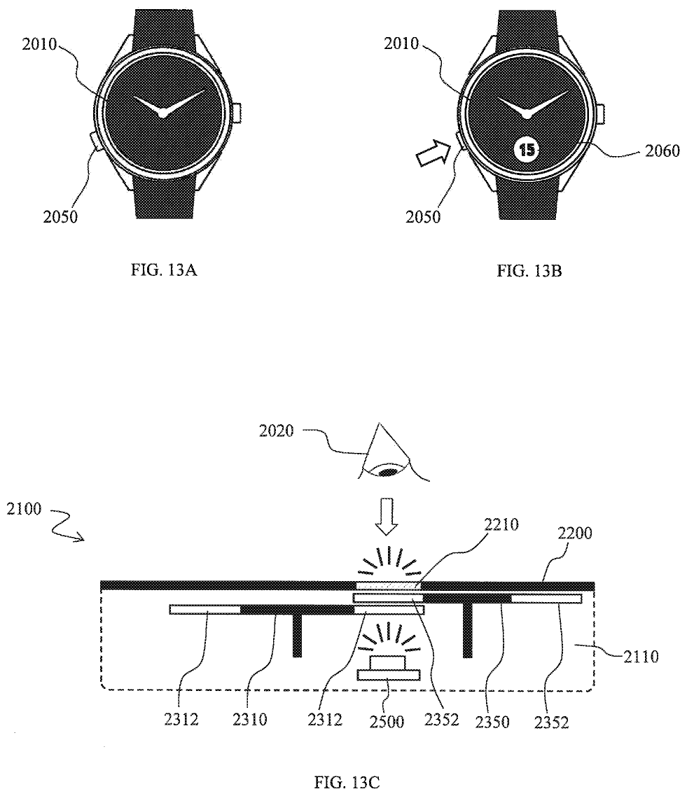

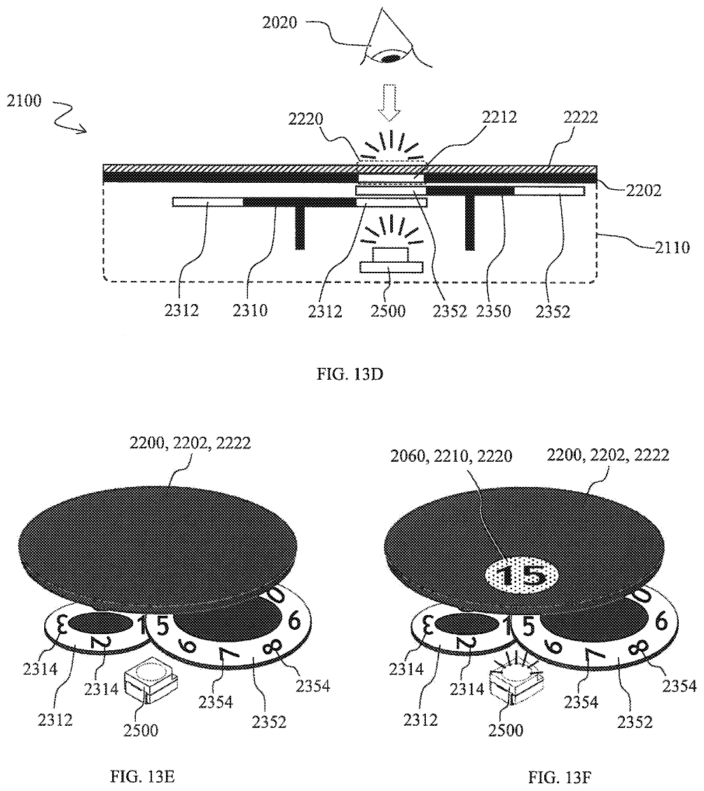

Referring now to FIGS. 13A-13F, the system 2100 of the invention may be used in a wristwatch 2010 to display the date, a “Grande Date”, but also to display any information and/or animation in any accessory to be worn by a wearer/user as a piece of apparel, an item of jewelry, a wristwatch, a pocket watch or any other fashion item, such as date, day, GMT, power reserve, astronomical information, symbol, logo, signs, initials, message, or an artistic image. The information or animation may remain fixed or change dynamically while the display is activated. The system may also take advantage of light color mixing to create the said artistic image.

Referring now to FIG. 13C, the watch dial 2200 is opaque but includes one or several semi-transparent windows 2210. The semi-transparent window 2210 is made of glass, frosted glass, or any other appropriate semi-transparent/translucent material, in a eight embodiment seamlessly integrated in the dial 2200. The dial 2200 and the semi-transparent window 2210 may have similar colors so that the semi-transparent window 2210 is not easy to spot by the user/wearer, preferably dark colors, for example black. The semi-transparent window may also be composed of several segments or even of a multitude of pinholes to create the semi-transparency. The segments or pinholes may be distributed with varying densities in different areas to create varying degrees of semi-transparency in these areas and so generating different luminosity for these areas when illuminated.

Referring now to FIG. 13D, in a ninth embodiment, the watch dial 2202 may present one or several holes 2212 and be completely covered with a layer of semi-transparent material 2222, resulting in an even more inconspicuous semi-transparent window 2220.

Referring now to FIG. 13A, FIG. 13C, FIG. 13D, and FIG. 13E, the watch case 2110 behind the dial 2102, 2202 is opaque so that no ambient light may enter, and as a result, the space behind the semi-transparent window 2210, 2220 is in the dark, and so the objects behind the semi-transparent window 2210, 2220 are invisible to the user/wearer 2020, and the semi-transparent window 2210, 2220 is nearly invisible. A rotating disk 2310 containing the mask 2312 carrying the tens inscriptions 2314 and a rotating disk 2350 containing the mask 2352 carrying the units inscriptions 2354 are installed behind the semi-transparent window 2210, 2220 at an appropriate location so as to present one of their inscriptions 2314, 2354 at a time behind the semi-transparent window 2210, 2220. The at least one light source 2500 is disposed behind the rotating disks 2310, 2350, its main lighting direction pointing towards the semi-transparent window 2210, 2220. The masks 2312, 2352 can be transparent or semi-transparent, can be colored or not, and be made of any appropriate material. The masks 2312, 2352 can also be fixed for constant information or transported by mechanical means other than rotating disks. They can also be positioned behind the semi-transparent window 2210, 2220 with levers, slides, or any mechanical mobilization means. The masks 2312, 2352 may carry any kind of inscriptions for example symbols, logos, artistic images, etc.

Referring now to FIG. 13B, FIG. 13C, FIG. 13D, and FIG. 13F, when the user/wearer presses the activation button 2050, the at least one light source 2500 is activated, projecting light through the masks 2312, 2352, generating an image 2060 on the semi-transparent window 2210, 2220 which is visible to the user/wearer 2020.

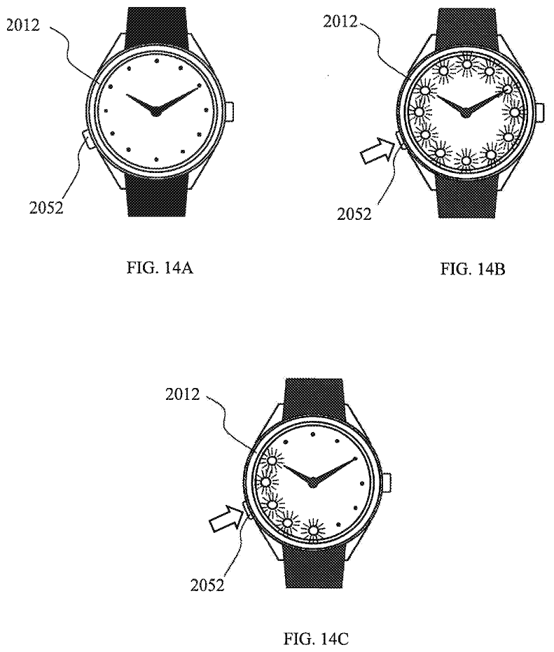

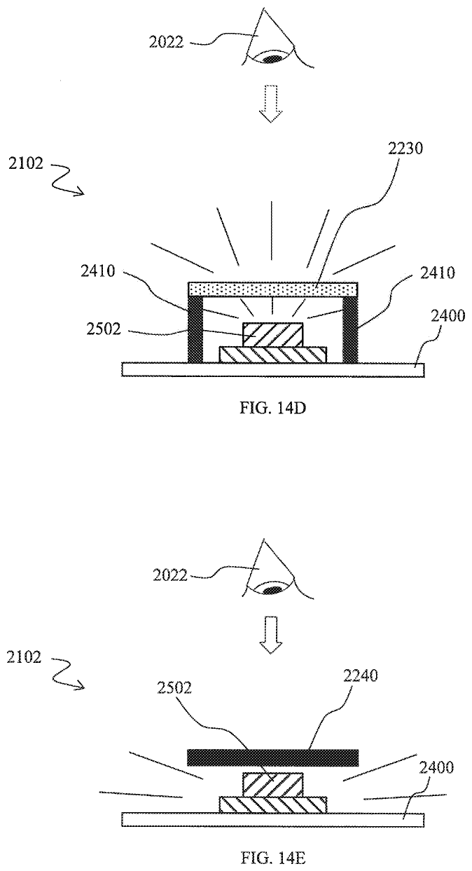

Referring now to FIGS. 14A-14E, the system 2102 of the invention may be used in a wristwatch 2012 as described herein, but also to display any information and/or animation in any accessory to be worn by a wearer/user as a piece of apparel, an item of jewelry, a wristwatch, a pocket watch or any other fashion item, such as date, day, GMT, power reserve, astronomical information, symbols, logo, signs, initials, messages, or an artistic image or images. The information or animation may remain fixed or change dynamically while the display is activated.

Referring now to FIG. 14A, the display of the invention is hidden via camouflaging in and/or on the watch dial, so that when the display is not activated, the user/wearer is not made easily aware of its presence. For example the display may consist of several light sources 2502 which are hidden via being disposed below or by being camouflaged as hours' indexes. In particular, in order to hide the presence of the light sources, the light sources are placed on a transparent substrate and the electrical connections are also transparent. The light source may also be of transparent luminous material layers.

Referring now to FIG. 14B, when the user/wearer pushes the activation button 2052, or as triggered by a program running in the watch 2012, the one or more light sources 2502 of the display are activated according to the information or animation to be displayed, for example lighting or flashing the hours' indexes.

Referring now to FIG. 14C, when the user/wearer pushes the activation button 52, or as triggered by a program running in the watch 2012, a part of the one or more light sources 2502 of the display are activated according to the information or animation to be displayed, for example lighting or flashing some of the hours indexes in order to indicate a value (in this case in FIG. 14C: 5 light sources are activated) or to animate a scene.

Referring now to FIG. 14D, the tenth embodiment of the system 2102 consists of installing one or more light sources 2502 on a dial 2400, optionally a transparent dial. The dial 2400 can be made of glass, of sapphire or any other transparent or non-transparent material appropriate for the function. The one or more light sources 2502 are installed individually or by groups underneath semi-transparent windows 2230. The semi-transparent window 2230 is made of glass, frosted glass, or any other appropriate semi-transparent material. The semi-transparent window 2230 may be decorated and/or colored so as to look like any traditional decoration or index, the semi-transparent windows can also contain partially transparent elements such as precious stones. Opaque sidewalls 2410 surrounding the light source 2502 ensure that no ambient light may be accidentally reflected in the watch and come back through the semi-transparent window 2230, which could give away its presence. As a result, the light source 2502, when not activated, is nearly invisible for the user/wearer. The electrical power necessary to activate the light source 2502 is transported by transparent conductors built on the dial 2400, so that they are invisible to the user/wearer. The transparent conductors can be made of ITO (indium tin oxide) or any other appropriate transparent conducting material. The transparent conductors may be deposited by traditional microfabrication processes.

Referring now to FIG. 14E, an eleventh embodiment of the system 2102 consists of installing one or more light sources 2502 on a dial 2400, optionally a transparent dial. The dial 2400 can be made of glass, of sapphire or any other transparent or non-transparent material appropriate for the function. The one or more light sources 2502 are installed individually or by groups under opaque screens 2240, so that the light sources 2502 are out of the field of view of the user/wearer. The opaque screens 2240 may be decorated and/or colored so as to look like any traditional decoration or index. When the light sources 2502 are activated, an effect of backlighting of the screens 2240 is obtained. The electrical power necessary to activate the light source 2502 is transported by conductors which are very thin, preferably transparent, built on the dial 2400, so that they are invisible to the user/wearer. The transparent conductors can be made of ITO (indium tin oxide) or any other appropriate transparent conducting material. The transparent conductors may be deposited by traditional microfabrication processes.

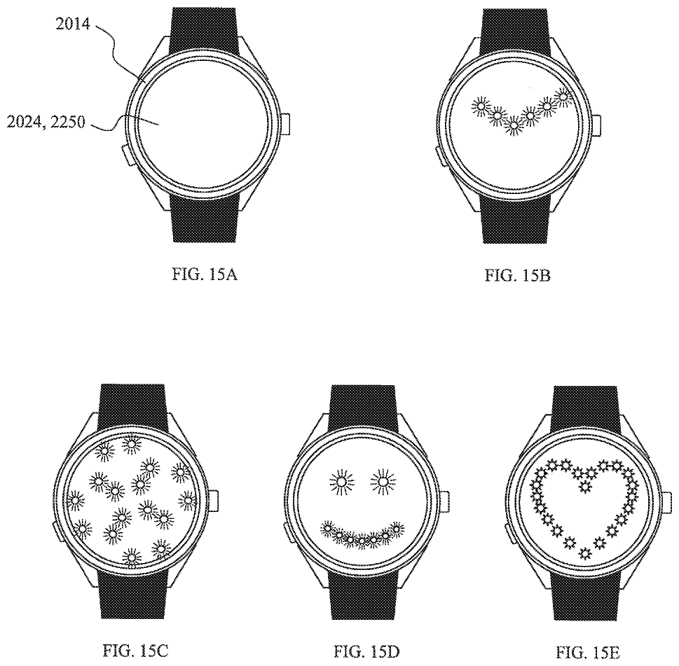

Referring now to FIGS. 15A-15E, a twelfth embodiment the system of the invention may be used in a wristwatch 2014 as described here, but also to display any information and/or animation in any accessory to be worn by a wearer/user as a piece of apparel, an item of jewelry, a wristwatch, a pocket watch or any other fashion item, such as date, day, GMT, power reserve, astronomical information, symbols, logo, astronomical constellations, signs, initials, messages, or an artistic image or images. The information or animation may remain fixed or change dynamically while the display is activated.

Referring now to FIG. 15A, in the twelfth embodiment, several light sources are hidden behind one semi-transparent dial 2250 covering the visible area of the wristwatch's face 2024, so that when the display is not activated, no tell-tale feature hints are visible for the user/wearer to recognize that a display may be present. The semi-transparent dial 2250 may be made of any semi-transparent material, may be decorated and/or colored so as to look like any traditional dial, and it may also contain partially transparent elements such as precious stones.

Referring now to FIGS. 15B-15E, when the display is activated, the light produced by the light sources is visible through the semi-transparent dial 2250 and forms an information/animation, such as indicating the time (FIG. 15B), producing an animation (FIG. 15C) and/or displaying symbols, logo, signs, initials, astronomic constellations, messages, or an artistic image or images (FIGS. 15D-15E). The information or animation may remain fixed or change dynamically while the display is activated.

In a thirteenth embodiment, the system 2102 is built using several dials 2400 installed at different heights within the watch, in order to create three dimensional luminous animations or indications.

In a fourteenth embodiment, the system 2100, 2102 includes fixed or mobile mirrors and/or semi-transparent or transparent prisms, generating luminous animations or indications.

It should be appreciated that the particular implementations shown and herein described are representative of the invention and its best mode and are not intended to limit the scope of the present invention in any way.

Moreover, the system contemplates the use, sale and/or distribution of any goods, services or information having similar functionality described herein.

The specification and figures should be considered in an illustrative manner, rather than a restrictive manner, and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

The invention can be summarized by the following feature sets.

1. A non-electric display system configured to be integrated in an accessory to be worn by a wearer/user as a piece of apparel, an item of jewelry, a wristwatch, a pocket watch or any other fashion item, wherein the system includes at least one electrical light source for illuminating the display, the light source being hidden when not activated.

2. The system of feature set 1, wherein the system displays an astronomical indication or animation and is configured to mimic observable reality.

3. The system of feature set 1, wherein the light source is one or more light emitting diodes (LED) or any other light producing elements, powered by one or more photovoltaic cells converting ambient light into electricity, by one or more batteries, by one or more electrochemical devices producing electricity, or by one or more micro-generators converting mechanical energy into electricity.

4. The system of feature set 1, wherein the energy to power the light source may be produced in advance and stored until use in one or more energy storage devices such as rechargeable batteries, electrochemical devices, mechanical energy storage arrangements such as springs, spiral springs, spring barrels, or fluids compressed in one or more reservoirs.

5. The system of feature set 1, wherein the light source is hidden from the field of view of the user/wearer behind an opaque screen and projects light around the screen, thus generating an animation or an indication.

6. The system of feature set 1, wherein the light source is mounted on a transparent substrate and the electrical connection are also transparent.

7. The system of feature set 2, wherein the system (60) mimics the reality by illuminating miniature substantially or partially spherical object (620) with a light source (630), the light source (630) being installed on a rotatable lever (632) whose rotation axis (634) is placed near the spherical object (620) and whose direction is as near as possible to the perpendicular of the observation axis.

8. The system of the above feature set, wherein, in order to represent moon phases, the rotatable lever (632) makes one turn in substantially 29.53 days, corresponding to the cycle of the moon, in which, preferably, a traditional moon phase mechanism is used.

9. The system of feature set 7, wherein, in order to ensure a realistic vision of the illumination of the spherical object (620), the system (60) is hidden below a mask (610), such as a dial of a wristwatch.

10. The system of feature set 7, wherein the field of vision of the observer's eye (602) is limited by a three dimensional cover (612), for example representing a telescope, so that the observer can only see a part of the system (60) through a magnifying lens or a combination of several lenses or a window (614), so that the ambient light has a very limited impact on the spherical object (620), and the most light illuminating the spherical object (620) comes from the light source (630).

11. The system of feature set 7, wherein in order to emphase the contrast between shadow and the illuminated part of the spherical object (620), the system is surrounded by light absorbing areas and the spherical object is coated with or formed of light sensitive material.

12. The system of feature set 1, wherein the system (70) illuminates a two dimensional (flat) display with a backlight.

13. The system of the above feature set, wherein an translucent diffusing window (720) with a representation of a spherical object (620) is illuminated by the backlight (730) which makes the spherical object appear full.

14. The system of the above feature set, wherein a rotating mask (732) with two openings (736) is placed between the light source (730) and the diffuser (720) allowing for masking a portion of the translucent window (720) that represents the unlit part of the spherical object.

15. The system of the above feature set, wherein the mask (732) is configured to turn at a rotation speed of 1 turn in 59.06 days representing two moon cycles.

16. The system of any one of the above four feature sets, wherein the system (70) is hidden below a cover (810) with an opening (812), and a diffusing window (820) is placed in or below the opening (812).

17. The system of any one of the above five feature sets, wherein the diffusing window (820) of the system (80) has engravings or decorations, such as representations of the surface of the spherical object represented, and wherein a rotating mask (832) has its axis of rotation (834) at the center of the system 80.

18. The system of the above feature set, wherein a light source (830) is located below the rotating mask (832), and illuminates the diffusing window (820) from below (relative to the observer's eye).

19. The system of the above feature set, wherein the rotating mask (832) has an opening (836) with an appropriate shape so that the clipped part of the light has a shape narrowing the real shadow of the light shadow and the rotating mask (832) has a rotation speed of one turn in 29.53 days, corresponding to one cycle of the moon.

20. A system indicating an astronomical position, the system being configured to mimic observable reality and to be integrated in an accessory to be worn by a wearer/user as a piece of apparel, an item of jewelry, a wristwatch, or any other fashion item, wherein the system (90) is hidden below a cover (910) having a window (920), wherein an image of a spherical object (620) is composed of diffusing light guides (936) which begin at the same point and end at the opposite side of the moon image.

21. A system indicating an astronomical position, the system being configured to mimic observable reality and to be integrated in an accessory to be worn by a wearer/user as a piece of apparel, an item of jewelry, a wristwatch, or any other fashion item, the system (100) providing a solution for the indication of the day-night position (day 1060/night 1070) around the globe, wherein the system (100) is composed of a three-dimensional representation of the terrestrial globe (1020) made of semi-transparent or translucent material, the globe (1020) being illuminated from inside by a light source 1030 or several light sources emitting in all directions so that the light distribution is substantially homogeneous.

22. A system indicating an astronomical position, the system being configured to mimic observable reality and to be integrated in an accessory to be worn by a wearer/user as a piece of apparel, an item of jewelry, a wristwatch, or any other fashion item, the system, the system having a light source (1130) which is not placed at the center of the globe (1120) but is offset and rotates around the central axis and wherein the clipping mask (1132) is placed close to the light source (1130) at a distance so that its shadow darkens half of the globe of the Earth, and wherein the rotating mask (1132) and the light source (1130) are rotating at the same speed and make one turn in 24 hours, and wherein the clipping mask (1132) can move up and down along the rotation axis, thanks to a vertical guide (1134), the up and down displacement of the mask (1132) along the axis moving the shadow so that the illuminated hemisphere (1160) makes an angle of up to plus or minus 23° 26′ 12″ with respect to its initial position.

23. A system indicating an astronomical position, the system being configured to mimic observable reality and to be integrated in an accessory to be worn by a wearer/user as a piece of apparel, an item of jewelry, a wristwatch, or any other fashion item, the system, the system (120) showing the indication of the moon phase on a timepiece with a liquid display, wherein the system is composed of a transparent top plate (1210) and a bottom plate (1212), the bottom plate (1212) containing a representation of the image, typically a moon face (1220), directly on it or under it and visible given the transparency of the plate, wherein the two plates (1210, 1212) are linked together by a flexible system (1214), typically a bellows, wherein a drop of liquid (1232) is trapped between the two plates (1210, 1212) and its shape and position is maintained by capillary forces.

24. A system indicating an astronomical position, the system being configured to mimic observable reality and to be integrated in an accessory to be worn by a wearer/user as a piece of apparel, an item of jewelry, a wristwatch, or any other fashion item, the system (120) having a watch dial (2200) which is opaque but includes one or several semi-transparent windows made of glass, frosted glass, or any other appropriate semi-transparent/translucent material, integrated in the dial (2200).

25. The system of the above feature set, wherein the semi-transparent material is composed of several segments or of a multitude of pinholes to create the semi-transparency.

26. The system of the above feature set wherein the segments or pinholes are distributed with varying densities in different areas to create varying degrees of semi-transparency in these areas and so generating different luminosity for these areas when illuminated

27. The system of the penultimate feature set, wherein the watch dial (2202) present one or several holes (2212) and be completely covered with a layer of semi-transparent material (2222), resulting in an even more inconspicuous semi-transparent window (2220).

28. A system indicating an astronomical position, the system being configured to mimic observable reality and to be integrated in an accessory to be worn by a wearer/user as a piece of apparel, an item of jewelry, a wristwatch, or any other fashion item, the system (2102) having one or more light sources (2502) disposed on a dial (2400), optionally a transparent dial made of glass, of sapphire or any other transparent or non-transparent material appropriate for the function.

29. A system indicating an astronomical position, the system being configured to mimic observable reality and to be integrated in an accessory to be worn by a wearer/user as a piece of apparel, an item of jewelry, a wristwatch, or any other fashion item, the system (2102) being used in a wristwatch (2014) and, in addition, displaying any information and/or animation in any accessory to be worn by a wearer/user selected from one of the group of indications consisting of date, day, GMT, power reserve, astronomical information, symbols, logo, astronomical constellations, signs, initials, messages, or an artistic image or images.

30. A system indicating an astronomical position, the system being configured to mimic observable reality and to be integrated in an accessory to be worn by a wearer/user as a piece of apparel, an item of jewelry, a wristwatch, or any other fashion item, the system (2102) built using several dials (2400) installed at different heights within the watch, in order to create three dimensional luminous animations or indications.

31. A system indicating an astronomical position, the system being configured to mimic observable reality and to be integrated in an accessory to be worn by a wearer/user as a piece of apparel, an item of jewelry, a wristwatch, or any other fashion item, the system (2100, 2102) including fixed or mobile mirrors and/or semi-transparent or transparent prisms, generating luminous animations or indications.

32. A wristwatch including the system of the invention, wherein the system is placed on the face of the wristwatch preferably at the 6 o'clock position or at the 3 o'clock position.

33. The wristwatch of the above feature set, wherein the display of the system of the invention is placed so as to be visible when the user/wearer's eye (22) is facing the face of the wristwatch (20).

34. The wristwatch of the penultimate feature set, wherein the system of the invention is constructed so that the user/wearer's eye (22) can only see the display when viewing it at a certain angle relative to the face of the wristwatch (20).

35. The system of feature set 1, wherein the light source is hidden behind a semi-transparent window in an otherwise opaque chamber and projects light through the semi-transparent window, so that the light is visible for the user/wearer, thus generating an animation or an indication.

36. The system of feature set 1, wherein the light source is hidden behind a semi-transparent window in an otherwise opaque chamber and projects light through a mask wearing at least one inscription on the semi-transparent window, so that the inscription is visible for the user/wearer on his side of the semi-transparent window, thus generating an animation or an indication.

Other characteristics and modes of execution of the invention are described in the appended claims.

Materials used for the realization of the present invention are chosen to be suitable and in compliance to the operating temperature range of the invention. Such materials are e.g. metals, polymers or glass, and in particular sapphire glass. The same goes for structures used for the realization of the present invention, such as e.g. bellows, chips, or intrinsic membranes, are configured to be suitable and in compliance to the operating temperature range of the invention.

Further, the invention should be considered as comprising all possible combinations of every feature described in the instant specification, appended claims, and/or drawing figures that may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-a-vis the public or third parties, no express or implied license is granted to prepare derivative works based on this patent specification, inclusive of the appendix hereto and any computer program comprised therein.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims that ultimately issue in this application.

1. A portable mechanical display system configured to be integrated in an accessory to be worn by a wearer/user as a piece of apparel, an item of jewelry, a wristwatch, a pocket watch or any other fashion item, wherein the system is hidden below a cover and has a window, the system including a mechanical display, a time-keeping mechanism, at least one light guide and at least two electrical light sources for illuminating the at least one lightguide, the at least two light sources being installed in such a way as to be invisible or integrated so as to be non-identifiable to the user/wearer, the at least one lightguide beginning at the same point and ending at an opposite side, both sides of the lightguides being arranged so that they present their coupling areas alongside each other and each facing at least one light source, wherein around each electrical light source one rotating mask is situated, each rotating mask being rotatably connected to the time-keeping mechanism and located between the mechanical display and the at least one lightguide.

2. The system of claim 1, wherein the system displays an astronomical indication or animation and is configured to mimic observable reality.

3. The system of claim 1, wherein the light source is one or more light emitting diodes (LED) or any other light producing elements, powered by one or more photovoltaic cells converting ambient light into electricity, by one or more batteries, by one or more electrochemical devices producing electricity, or by one or more micro-generators converting mechanical energy into electricity.

4. The system of claim 1, wherein the energy to power the light source may be produced in advance and stored until use in one or more energy storage devices such as rechargeable batteries, electrochemical devices, mechanical energy storage arrangements such as springs, spiral springs, spring barrels, or fluids compressed in one or more reservoirs.

5. The system of claim 1, wherein the light source is hidden from the field of view of the user/wearer behind an opaque screen and projects light around the screen, thus generating an animation or an indication.

6. The system of claim 1, wherein the light source is of transparent luminous material layer.

7. The system of claim 1, wherein the light source is mounted on a transparent substrate and the electrical connection is transparent.

8. The system of claim 7, wherein the electrical connection is made of ITO (indium tin oxide).

9. The system of claim 2, wherein the system mimics the reality by illuminating miniature substantially or partially spherical object with a light source, the light source being installed on a rotatable lever whose rotation axis is placed near the spherical object and whose direction is as near as possible to the perpendicular of the observation axis.

10. The system of the above claim, wherein, in order to represent moon phases, the rotatable lever makes one turn in substantially 29.53 days, corresponding to the cycle of the moon, in which, preferably, a traditional moon phase mechanism is used.

11. The system of claim 9, wherein, in order to ensure a realistic vision of the illumination of the spherical object, the system is hidden below a mask, such as a dial of a wristwatch.

12. The system of claim 9, wherein the field of vision of the observer's eye is limited by a three dimensional cover, for example representing a telescope, so that the observer can only see a part of the system through a magnifying lens or a combination of several lenses or a window, so that the ambient light has a very limited impact on the spherical object, and the most light illuminating the spherical object comes from the light source.

13. The system of claim 9, wherein in order to emphase the contrast between shadow and the illuminated part of the spherical object, the system is surrounded by light absorbing areas and the spherical object is coated with or formed of light sensitive material.

14. The system of claim 1, wherein the system illuminates a two dimensional (flat) display with a backlight.

15. The system of the above claim, wherein a translucent diffusing window with a representation of a spherical object is illuminated by the backlight which makes the spherical object appear full.

16. The system of claim 1, wherein the mask is configured to turn at a rotation speed of 1 turn in 59.06 days representing two moon cycles.

17. The system of claim 14, wherein the system is hidden below a cover with an opening, and a diffusing window is placed in or below the opening.

18. The system of the above claim, wherein the diffusing window of the system has engravings or decorations, such as representations of the surface of the spherical object represented.

19. The system of the above claim, wherein the light source is located below the rotating mask, and illuminates the diffusing window from below (relative to the observer's eye).

20. The system of the above claim, wherein the rotating mask has an opening with an appropriate shape so that the clipped part of the light has a shape narrowing the real shadow of the light shadow and the rotating mask has a rotation speed of one turn in 29.53 days, corresponding to one cycle of the moon.

21. A wearable mechanical display system indicating an astronomical position, the system being configured to mimic observable reality and to be integrated in an accessory to be worn by a wearer/user as a piece of apparel, an item of jewelry, a wristwatch, or any other fashion item, wherein the system is hidden below a cover having a window, wherein an image of a spherical object is composed of diffusing light guides which begin at the same point and end at the opposite side of a moon image.

22. (canceled)

23. (canceled)

24. A portable mechanical display system indicating an astronomical position, the system being configured to mimic observable reality and to be integrated in an accessory to be worn by a wearer/user as a piece of apparel, an item of jewelry, a wristwatch, or any other fashion item, the system showing the indication of the moon phase on a timepiece with a liquid display, wherein the liquid display is composed of a transparent top plate and a bottom plate, the bottom plate containing a representation of the image, typically a moon face, directly on it or under it and visible given the transparency of the plate, wherein the two plates are linked together by a flexible system, typically a bellows, wherein a drop of liquid is trapped between the two plates and its shape and position is maintained by capillary forces.

25.-37. (canceled)
